(19) United States
(12) Patent Application Publication
(10) Pub. No.: US 2015/0154605 A1
(43) Pub. Date: Jun. 4, 2015

(54) METHOD, ELECTRONIC SYSTEM OF WARRANTY ACCOUNTING AND PROCESSING METHOD CONCERNING WARRANTY ACCOUNTING

(71) Applicant: Artur Sanasarovich Arevshatian, Kiev (UA)

(72) Inventor: Artur Sanasarovich Arevshatian, Kiev (UA)

(21) Appl. No.: 14/119,545

(22) PCT Filed: Jun. 13, 2012
(86) PCT No.: PCT/UA2012/000063

§ 371 Date: Nov. 22, 2013

(30) Foreign Application Priority Data
May 30, 2012 (UA) A2012 06612

(51) Int. Cl. G06Q 30/00

(52) U.S. Cl. CPC G06Q 30/012

(57) ABSTRACT

The invention relates to registration, conversion and saving the digital data concerning warranty accounting. The access to the processing center with database servers is provided via web-based platforms for customer, manufacturer and service point for customer identification in the database by customer warranty cards. The invention allows simplifying the accounting and administration of such commitments also resulting in more services availability for customer.

### FIELD OF THE INVENTION

The invention relates to registration, conversion and storage of digital information concerning warranty accounting of goods.

### BACKGROUND OF THE INVENTION

The current decisions include those concerning customer service during the warranty and post-warranty period with the events legally determined as: Order of the Cabinet of Ministers of Ukraine of Apr. 11, 2002 No. 506 “On approval of the warranty (maintenance) or warranty replacement for sophisticated household goods”. It is to be noted that the Order includes only normative principles of rights and obligations of producer and clients (consumers) without specifying the material and technical base, which would be carried out by the warranty accounting.

### BRIEF DESCRIPTION OF THE DRAWINGS

FIG. 1 presents the scheme explaining the invention operation.

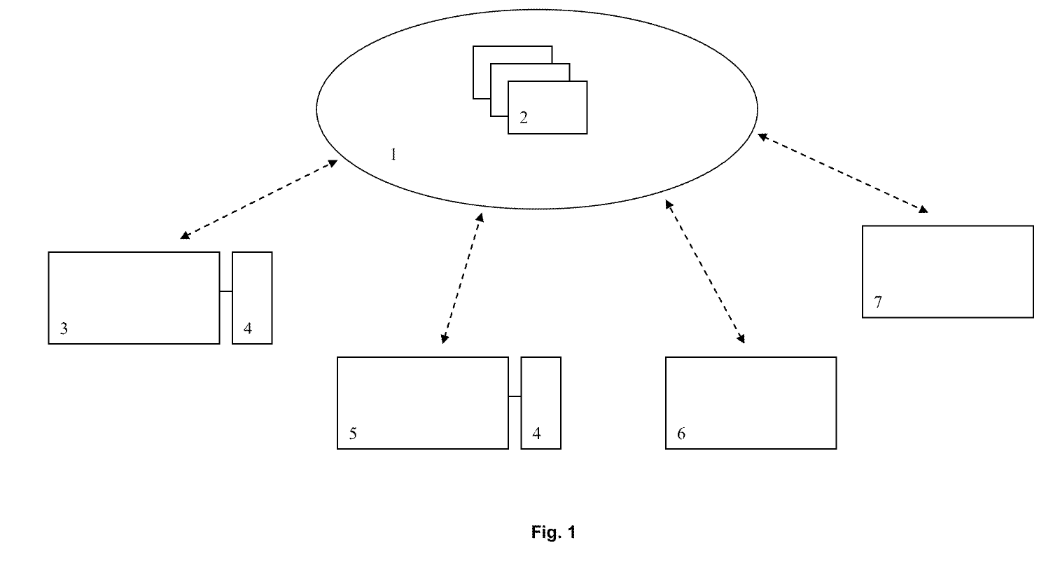

The following designations are used:

1—Processing center,

2—Servers for database,

3—Point of sale,

4—The scanning terminal unit is structurally similar both to point of sale and service point,

5—web-based platform for service point,

6—web-based platform for customer,

7—web-based platform for producer.

### SUMMARY OF THE INVENTION

### Thesaurus

Processing center means many server stations located at geographical distance mostly in several countries connected by communication links i.e., Internet, satellite or optical fiber links. The server station includes accessories to support and ensure the uninterrupted operation of the equipment: many servers, data warehouse, uninterruptible power supply units, internet switches etc.

The database means regulated database system located at servers and data warehouse. The database includes information concerning products, their availability at points of sale, warranty period and maintenance service for each product, quantity of registered warranty cards and associated information regarding the owners of the cards and manufacturers, etc. The access to the database is provided via web-based platforms for customer, manufacturer and point of sale.

The electronic customer warranty card means plastic card containing the card number, recorded both for machine-readable and visual recognition, with also a telephone number of customer support provided.

The scanning terminal unit in points of sale and service points allows scanning the data from the warranty card and submitting it to the processing centers. The terminal unit prints the information, for instance, printout slips via printer. The data scanned by the terminal unit is submitted to the processing center for processing of the number of warranty card and information on goods including: manufacturer's name, model name, serial number (if available), date and place of production, etc. The ensemble of terminal units forms the warranty terminals network.

Web-based platform means database-backed interworking interface with different access levels. The web-based platform for customer allows to create a customer web page, revise the purchase history, monitor the state of maintenance service online, receive messages from both points of sale and manufacturer. The web-based platform for maintenance service allows converting both warranty status and service period, change status of the maintenance service, administration of the financial and economic relations with the manufacturer, etc. The web-based platform for manufacturer tracks the goods sale based on their type, point of sale, geographical region, number of customer warranty card etc. The web-based platform allows accessing the database with certain identified restrictions: the web-based platform for point of sale or service allows no revision of the manufacturer offers sent to the customer or the purchase list of a customer.

The invention is designed to establish the warranty accounting method. The system allows solving the following issues:
Online tracking of goods at the time of retail sale,
Online tracking of services points availability and their performance,
Online tracking of goods quality based on customer requests for repair of the goods purchased,
ensuring the customer rights without documents proving their purchase when applying to the service points by obtaining information about the customer and the goods from the database (including model name and number, manufacturer, date and place of sale, etc.).

The invention allows to simplify the accounting and administration of such commitments to clients also resulting in more services availability for customer.

The technical result is obtained by the following combination of essential characteristics common for method and system of electronic warranty accounting. Thus, the warranty accounting method characterized in:
introducing into the database the information on goods model, manufacturer name, warranty period and date of sale if it was realized,
providing the customer both with the goods and its warranty card on which the machine-readable code is written, associated with the card number and contact details of customer support line; reading these data from the card by scanning terminal unit, locating this terminal unit both in service points and points of sale;
submitting the data on goods and warranty card number to the processing center which contains the database for return confirmation of goods availability in the database and also for information on the purchase made via web-based platform for manufacturer; associating these goods data with the number of customer warranty card,
introducing into the database the customer data via web-based platform for customer for the registration into the database by creating the customer's web page,
providing the customer with the online access to his/her web page allowing to recover data concerning purchases made, warranty validity, state of the goods at the service points, new manufacturer offers, list of service points located far forth from the customer, online tracking of repair state of the goods at the service point as well as providing the possibility of integration of warranty cards data on the customer web page if he/she have more than one warranty card
introducing of warranty card data by terminal unit scanning at the service point for and check the state of the warranty period of the goods via web-based platform for service point,
sending data on goods submitted for warranty to the database of processing center for their presenting on the web-based platform for manufacturer,
changing the state of products' repair via web-based platform for service point,
releasing a product at the service point to the customer sending the data on presenting the warranty in the database for further recovery of such data on both web-based platform for customer and manufacturer,
monitoring the sales of products according to a type, point of sale, geographic region, quantity of customer warranty card via web-based platform for manufacturer,
administering the financial and economic relations with the service point based on data on warranty service for goods via web-based platform.

The electronic warranty accounting system characterized in that contains:
processing center keeping the database of goods, their models, date and place of sale, purchases made, warranty validity, state of goods given for maintenance, list of service points
the terminal unit installed in points of sale and service points and suitable for reading the number of warranty card and submitting it to the processing center and receiving its response; besides the terminal possesses the means for slip print,
web-based platform for customer for access to the database of the processing center, designed for data creation concerning purchases made, warranty validity, state of goods submitted to service points, new manufacturer offers for purchase, list of service points far forth from the customer, online tracking of repair state at the service point as well as data integration on the web page if the customer possesses more than one warranty card,
web-based platform for manufacturer for access to the database of processing center designed for sale tracking of goods according to their type, point of sale, geographical region, number of customer warranty card, data recovery for warranty obligations, administering of financial and economic relations with the service point based on the submitted data concerning goods maintenance and sending offers on new goods,
web-based platform for service point for access to the database of processing center designed for checking the data of receiving the goods for warranty repair, state and term of goods warranty service, introduction of data regarding repair state, submitting data on warranty obligations, administering the financial and economic relations with the manufacturer based on submitted data concerning service maintenance

The method of data processing related to warranty accounting characterized in:
locating of database on servers of processing center
providing access to the database via web-based platform for customer, manufacturer and service point, where
reconstructing data concerning purchases made, warranty validity, state of goods, submitted for service points, new purchase offers from manufacturer, list of service points at certain distance, online tracking regarding the repair state of goods in service point as well as providing the possibility of data integration on web page if customer has more than one warranty card via web-based platforms of the customer
monitoring the retail sale of goods via web-based platform for manufacturer according to the type, point of sale, geographical region, number of customer warranty card, data recovery on warranty obligations performed, administering financial and economic relations with service point based on submitted data concerning service maintenance of goods, sending to customer new purchase offers of goods,
checking the data of goods receiving for service maintenance, checking state and term of such maintenance, introducing the data concerning the repair state, forwarding data on warranty obligations performed, administering financial and economic relations with manufacturer based on data submitted on service maintenance via web-based platform of service point.

The invention is realized the following way:

If the goods (product) require warranty (service) maintenance, the staff from the point of sale (3) while purchasing shall scan the goods data by terminal unit (4), (including manufacturer, model, serial number etc) as well as the number of customer warranty card. The terminal unit (4) sending the data to the database located on servers (2) of processing center (1) for further processing via available communication links, for instance, telephone or mobile or internet ones. After the data is processed in the processing center the database sends the confirmation of registration of the goods data or its derivative information, particularly including name of manufacturer, model and serial number etc. in warranty database. The goods are sold with data introducing into the database concerning the card number of the purchaser, date and place of sale, information on goods. If the goods fail to be registered in the database for any reason the negative response shall be submitted with the precise reasons for registration refusal (for instance: wrong name of manufacturer, model, serial number etc). The response is printed by terminal unit as slip in hard copy. If the customer fails to possess the warranty card while purchasing, he/she shall be provided with the new warranty card by the staff at the point of sale. If the customer forgets such warranty card at home, it is enough just to call its number and enter it into the terminal unit. Same relates to the Internet sale when the customer enters his/her number of warranty number, if he/she possesses such card or the customer shall ask the online-store (online point of sale) to issue a new warranty card.

If the customer receives a new card, he/she can any time register it in his/her name via web-based platform (6) for customer. He/she shall enter his/her personal information on his/her web page. For proving the ownership of goods purchased, for instance in loss event the customer shall submit correct personal data.

If the customer possesses several warranty cards, then he/she can combine them all in his/her account on the web portal. Besides the customer can deliberately leave either one active card with its number associated with all the actions performed by the customer concerning purchase or submitting to service maintenance or other and also several cards. The latter case the information from all the customer cards shall be synchronized with other cards.

After registration, the customer is able to see the list of purchases made, registered with his/her card(s), warranty state of goods, proposals for extending the warranty from the manufacturer, personalized new offers, warranty policy and instructions for use or purpose, recall notices, list of nearest service points according to each commodity, contact details, prices, conditions of reception and delivery of the goods upon delivery of goods purchased for repair—the state of repairs, as well as all the service history of the goods. If personal web page be somehow changed (including data on new purchases made, warranty cards, submitting to service maintenance, change of repair state, receipt from repair, new messages etc); the customer may choose alert type either via mobile phone including incoming call, SMS or USSD messages or via e-mail etc.

The web-based platforms can be located in electronic means allowing remote data exchange. Thus, such electronic means may include personal computer, PDA, smart phones, laptops, notebooks, POS-terminals, mobile phones.

The manufacturers of goods can via their own web-based platform (7) receive the following data from the database: online tracking of retail sales in all the points of sale or regions and areas. The goods categories as well as the number of customer warranty cards help perform online tracking the quality of service maintenance and also all the data required for financial and economic settlement with the service points. By tracking the customer purchases the manufacturers can make personalized purchase offers.

The service points via the web-based platform (5) can access the information from the database. The goods can be submitted to repair or requested for service in the web-based platform by entering its characteristics and checking the warranty state. The warranty card data is scanned by the terminal unit (4) or its number is entered via web-based platform of service point. The service points also can advertise their services in their working areas according to the goods categories served. The given option can be realized by adding the list of service points to the web-based platform for customer. By submitting for repair or service the web-based platform for service point contains its processing part allowing quick, easy and reliable administering of financial and economic relations with manufacturer. The service points also can download necessary service instructions from the manufacturer.

### BEST MODE FOR CARRYING OUT THE INVENTION

The company “Klavasonik” signed and entered into a contract for warranty maintenance with the issuer of Electronic Warranty Cards. “Klavasonik” via its own web-based platforms downloads to the databases all the information required: list of models, serial numbers, maintenance specifications, goods/models warranty terms, list of points of sale with certain goods presented, list of service points, where the goods may or shall be serviced. The issuer of warranty cards installs its terminal units in point of sales and service points to provide new warranty cards pursuant to certain terms. By purchasing at point of sale the customer is provided with warranty cards (if the customer fails to possess such card), scan both cards and goods data, submit request to the database where validity of such data is checked. With database response on goods availability the validity confirmation is printed by the terminal unit.

Afterwards the customer can any time register his/her card in personal page of database via web-based platform for customer and access the services of such database on his/her personal web page. When maintenance or any other services are required the customer never surfs the web-sites of numerous manufacturers but just enters his/her page and submits request to the nearest service point via any means suitable including sending message from his/her web-page, printed at terminal unit of service point, e-mail, telephone or mobile communications or SMS. Such messages are duplicated to the manufacturer for control of the customer service quality. If the customer for any reasons has no internet access, he/she can make a phone call to the single telephone number on the map, valid across the customer support line with all the necessary actions performed by support line operator. If the customer loses the warranty card and fail to remember the telephone number, he/she can learn it at any point of sale for such goods or from the reference book. While calling the customer is identified by full name and address stated while registration.

The service point submits the information on goods for repair, check the given information including: warranty state, the availability of the service documentation and technical regulation of service from the manufacturer, etc. Then necessary actions are performed concerning warranty and maintenance services. The service point report and goods transfer report are automatically submitted to “Klavasonik” for service quality control. “Klavasonik” automatically receives all the online information on commercial and service operations for quick control of service quality of commercial and service agents, for quick and effective (computerized) calculation of financial compensation to these agents, take necessary actions regarding elimination or correction of marketing disadvantages on certain areas or regions or by certain gropes or goods categories.

### INDUSTRIAL APPLICABILITY

The invention can be used for creation of united convenient accountancy system of warranty obligations of manufacturers before their customers which can also be applied for any, separate or several manufacturers, possessing of warranty or service obligation under current legislation.

1. A warranty accounting method characterized in:
introducing into the database the information on goods model, manufacturer name, warranty period and date of sale if it was realized,
providing the customer both with the goods and its warranty card on which the machine-readable code is written, associated with the card number and contact details of customer support line; reading these data from the card by scanning terminal unit, locating this terminal unit both in service points and points of sale;
submitting the data on goods and warranty card number to the processing center which contains the database for return confirmation of goods availability in the database and also for information on the purchase made via web-based platform for manufacturer; associating these goods data with the number of customer warranty card,
introducing into the database the customer data via web-based platform for customer for the registration into the database by creating the customer's web page,
providing the customer with the online access to his her web page allowing to recover data concerning purchases made, warranty validity, state of the goods at the service points, new manufacturer offers, list of service points located far forth from the customer, online tracking of repair state of the goods at the service point as well as providing the possibility of integration of warranty cards data on the customer web page if he/she have more than one warranty card,
introducing of warranty card data by terminal unit scanning at the service point for and check the state of the warranty period of the goods via web-based platform for service point,
sending data on goods submitted for warranty to the database of processing center for their presenting on the web-based platform for manufacturer,
changing the state of goods repair via web-based platform for service point,
releasing the goods at the service point to the customer sending the data on presenting the warranty in the database for further recovery of such data on both web-based platform for customer and manufacturer,
monitoring the sale of goods according to the goods type, point of sale, geographic region, number of customer warranty card via web-based platform for manufacturer,
administering the financial and economic relations with the service point based on data on warranty service for goods via web-based platform.

2. An electronic warranty accounting system is characterized in that contains:
processing center keeping the database of goods, their models, date and place of sale, purchases made, warranty validity, state of goods given for maintenance, list of service points
the terminal unit installed in points of sale and service points and suitable for reading the number of warranty card and submitting it to the processing center and receiving its response; besides the terminal possesses the means for slip print,
web-based platform for customer for access to the database of the processing center, designed for data creation concerning purchases made, warranty validity, state of goods submitted to service points, new manufacturer offers for purchase, list of service points far forth from the customer, online tracking of repair state at the service point as well as data integration on the web page if the customer possesses more than one warranty card,
web-based platform for manufacturer for access to the database of processing center designed for sale tracking of goods according to their type, point of sale, geographical region, number of customer warranty card, data recovery for warranty obligations, administering of financial and economic relations with the service point based on the submitted data concerning goods maintenance and sending offers on new goods,
web-based platform for service point for access to the database of processing center designed for checking the data of receiving the goods for warranty repair, state and term of goods warranty service, introduction of data regarding repair state, submitting data on warranty obligations, administering the financial and economic relations with the manufacturer based on submitted data concerning service maintenance.

3. A method of data processing related to warranty accounting characterized in:
locating of database on servers of processing center,
providing access to the database via web-based platform for customer, manufacturer and service point, where
reconstructing data concerning purchases made, warranty validity, state of goods, submitted for service points, new purchase offers from manufacturer, list of service points at certain distance, online tracking regarding the repair state of goods in service point as well as providing the possibility of data integration on web page if customer has more than one warranty card via web-based platforms of the customer,
monitoring the sale of goods via web-based platform for manufacturer according to the type, point of sale, geographical region, number of customer warranty card, data recovery on warranty obligations performed, administering financial and economic relations with service point based on submitted data concerning service maintenance of goods, sending to customer new purchase offers of goods,
checking the data of goods receiving for service maintenance, checking state and term of such maintenance, introducing the data concerning the repair state, forwarding data on warranty obligations performed, administering financial and economic relations with manufacturer based on data submitted on service maintenance via web-based platform of service point.
